(19) United States
(12) Patent Application Publication
(10) Pub. No.: US 2018/0339316 A1
(43) Pub. Date: Nov. 29, 2018

(54) FLUID TEMPERATURE CONTROL SYSTEM AND METHOD FOR DECOATING KILN

(71) Applicant: Novelis Inc., Atlanta, GA (US)

(72) Inventors: JungYoung Son, Ulsan (KR); Edwin L. Rauch, Fulton, NY (US); Augusto Cesar Silva, Roswell, GA (US)

(73) Assignee: Novelis Inc., Atlanta, GA (US)

(21) Appl. No.: 15/989,949

(22) Filed: May 25, 2018

Related U.S. Application Data
(60) Provisional application No. 62/511,378, filed on May 26, 2017.
(60) Provisional application No. 62/524,649, filed on Jun. 26, 2017.

(51) Int. Cl. B08B 7/00; F23G 7/06; F23G 5/50

(52) U.S. Cl. CPC B08B 7/0085; F23G 5/50; F23G 7/065

(57) ABSTRACT

A cooling system for a decoating system may include a kiln sprayer configured to selectively inject a coolant into the kiln to control a temperature of a gas within the kiln. The cooling system may also include a return sprayer configured to selectively cool a gas flowing from the afterburner to the kiln with a coolant. Alternatively or additionally, a heat exchange system for a decoating system may be used that includes a heat exchanger and a steam generator. The heat exchanger is configured to cool a gas flowing from the afterburner to the kiln, and the steam generator is configured to cool gas discharged from the afterburner and not directed to the heat exchanger.

### REFERENCE TO RELATED APPLICATIONS

This application claims the benefit of U.S. Provisional Application No. 62/511,378, filed on May 26, 2017 and entitled FLUID TEMPERATURE CONTROL SYSTEM AND METHOD FOR DECOATING KILN, and U.S. Provisional Application No. 62/524,649, filed on Jun. 26, 2017 and entitled FLUID TEMPERATURE CONTROL SYSTEM AND METHOD FOR DECOATING KILN, the disclosures of which are hereby incorporated by reference in their entireties.

### FIELD OF THE INVENTION

This application relates to metal recycling, and more particularly to decoating systems for metal recycling.

### BACKGROUND

During metal recycling, metal scrap (such as aluminum or aluminum alloys) are crushed, shredded, chopped, or otherwise reduced into smaller pieces of metal scrap. Oftentimes, the metal scrap has various coatings, such as oils, paints, lacquers, plastics, inks, and glues, as well as various other organic contaminants such as paper, plastic bags, polyethylene terephthalate (PET), sugar residues, etc., that must be removed through a decoating process before the metal scrap can be further processed and recovered.

During decoating with a decoating system, the organic compounds in the coatings of the metal scrap are removed by heating up the scrap in a kiln and incinerating the evaporated organic compounds in an afterburner as part of a main gas flow. The afterburner generally operates at a temperature that is much greater than the temperature of the kiln.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

In various examples, a decoating system includes an afterburner, a kiln, and a cooling system. The cooling system includes a return sprayer configured to selectively cool a return gas flowing from the afterburner to the kiln with a coolant.

According to various examples, a decoating system includes a kiln and a cooling system. The cooling system includes a kiln sprayer configured to selectively inject a coolant into the kiln to control a temperature of a gas within the kiln.

In some examples, a decoating system includes an afterburner, a kiln, and a heat exchange system that includes at least one heat exchanger. The at least one heat exchanger of the heat exchange system is configured to reduce a temperature of a return gas flowing from the afterburner to the kiln. In various examples, the heat exchange system reduces the temperature of the return gas from an afterburner operating temperature to a kiln operating temperature. In other examples, the heat exchange system reduces the temperature of the return gas from the afterburner operating temperature to an intermediate temperature between the afterburner operating temperature and the kiln operating temperature.

According to some examples, a decoating system includes a kiln, an afterburner configured to discharge an exhaust gas, and a heat exchange system. The heat exchange system includes a steam generator and a heat exchanger. The heat exchanger is configured to cool at least some of the exhaust gas that is directed from the afterburner to the kiln as return gas. The steam generator is configured to cool the exhaust gas that is not cooled by the heat exchanger.

In various examples, a decoating system includes a kiln configured to discharge a kiln gas, a cyclone (or other suitable solid/gas separator), and an afterburner. The cyclone is configured to receive the kiln gas, filter both inorganic and organic particulate matter from the kiln gas, and discharge the filtered kiln gas. The afterburner is configured to heat the filtered kiln gas and discharge an exhaust gas. At least some of the exhaust gas is diverted as return gas flowing from the afterburner to the kiln. The decoating system also includes a heat exchange system with a heat exchanger, which is configured to cool the return gas, and a cyclone control system, which is configured to control a cyclone temperature of the cyclone.

According to some examples, a method of controlling a temperature in a decoating system includes measuring a return gas temperature of a gas flowing from an afterburner of the decoating system to a kiln of the decoating system and comparing the return gas temperature to a kiln operating temperature of the kiln. The method also includes activating a return sprayer of a cooling system and injecting a coolant into the gas to cool the gas if the return gas temperature is greater than the kiln operating temperature.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a schematic diagram depicting a decoating system including a cooling system according to aspects of the present disclosure.

FIG. 2 is a flowchart depicting a temperature control process for the decoating system of FIG. 1.

FIG. 3 is a flowchart depicting a temperature control process for the decoating system of FIG. 1.

FIG. 4 is a flowchart depicting a temperature control process for the decoating system of FIG. 1.

FIG. 5 is a schematic diagram depicting another decoating system including a cooling system according to aspects of the present disclosure.

FIG. 6 is a schematic diagram depicting another decoating system including a cooling system according to aspects of the present disclosure.

FIG. 7 is a flowchart depicting an exemplary temperature control process for the decoating system of FIG. 1.

FIG. 8 is a flowchart depicting an exemplary temperature control process for the decoating system of FIG. 1.

### DETAILED DESCRIPTION

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

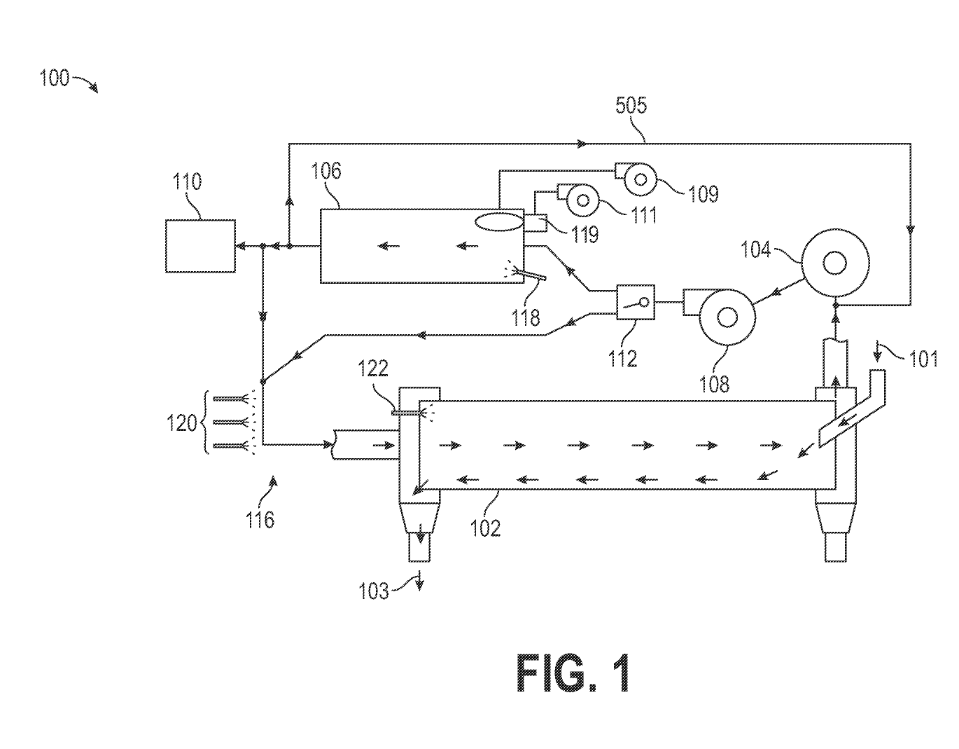

FIG. 1 illustrates a decoating system 100 for removing coatings from metal scrap, such as aluminum or aluminum alloys, according to aspects of the present disclosure. The decoating system 100 generally includes a kiln 102, such as a counterflow kiln, and an afterburner 106. In some examples, a cyclone 104 (or other suitable solid/gas separator) is provided between the afterburner 106 and the kiln 102 to filter out larger particulate matter from the gas flow from the kiln 102 before it enters the afterburner 106. A recirculation fan 108 may further be included for directing the gas flow from the cyclone 104 to the afterburner 106. Air movers 109 and 111 (such as fans) may be included for providing oxygen (air mover 109) and combustible air (air mover 111) to the afterburner 106. As described in detail below, the decoating system 100 further includes a cooling system 116.

During a decoating process with the decoating system 100, metal scrap 101 is fed into the kiln 102. Hot gas within the kiln 102, which is at a kiln operating temperature of from about 200° C. to about 600° C., such as about 550° C.+/−20° C., removes the coatings from the metal scrap, and vaporizes and/or thermally cracks and vaporizes the organic coatings without melting the scrap metal. As used herein, the kiln operating temperature refers to a temperature at an entrance end of the kiln. The decoated scrap metal 103 is removed from the kiln 102 for further processing and ultimately processing into new aluminum products. From the kiln 102, the gas containing the vaporized organic compounds and inorganic dust is directed to the cyclone 104 where larger particulates are filtered from the gas as dust. A kiln exit gas temperature refers to a temperature of the gas exiting the kiln 102. The filtered gas from the cyclone 104 is directed to the afterburner 106, which heats the gas from about 700° C. to about 1000° C., such as about 800° C.+/−20° C., to incinerate remaining organic compounds in the gas. The afterburner 106 may include a hot air burner 119 or other suitable device for heating the gas. From the afterburner 106, the gas is directed to an exhaust system 110, which may be a bag house or other similar processing system.

In various examples, some of the return gas exiting the afterburner 106 can also be optionally selectively recirculated back to the cyclone 104 as recirculated gas 505 to control a temperature of the cyclone 104. In some examples, as illustrated in FIGS. 1, 5, and 6, some of the gas exiting the afterburner 106 is recirculated back to the kiln 102 as return gas to be used as at least some of the heating gas within the kiln 102. In these examples, because the return gas exiting the afterburner is at the temperature of from about 700° C. to about 1000° C., such as 800° C., the gas must be cooled down to within a kiln operating temperature such that the gas can be used with the kiln 102.

In some exemplary decoating systems, the return gas exiting the afterburner 106 is cooled by mixing it with some of the gas that exits the kiln 102, which is at a temperature of from about 100° C. to about 500° C., such as about 320° C. In these systems, a diverter 112 is provided to selectively divert a portion of the gas (bypass gas) from the cyclone 104 rather than entering the afterburner 106. For example, when the temperature of the return gas exiting the afterburner 106 exceeds the kiln operating temperature, the diverter 112 directs the bypass gas from the cyclone 104 to mix with the return gas exiting the afterburner 106. However, the bypass gas includes a relatively high concentration of organic compounds because it has not been incinerated by the afterburner 106. When the bypass gas is mixed with the return gas and the mixed gas is directed into the kiln 102, the organic compounds from the bypass gas are reintroduced into the kiln 102. This accelerates the organic compounds concentration in the decoating system, which may lead to dangerous situations within the system. For example, organic compounds reintroduced into the kiln 102 can release heat energy into the kiln 102, which raises temperatures inside the kiln 102 and may result in thermitting (burning of metal inside the kiln 102) or other serious damage to the decoating system equipment.

The cooling system 116 is configured to reduce the amount of organic compounds returning to the kiln 102 by reducing or eliminating the need to reintroduce the bypass gas exiting the cyclone 104 back into the kiln 102. The cooling system 116 is further configured to control temperature excursions and reduce or prevent thermitting. Moreover, the cooling system 116 is configured to provide various locations where the system can cool various components of the decoating system 100 (such as the kiln 102) during the decoating process.

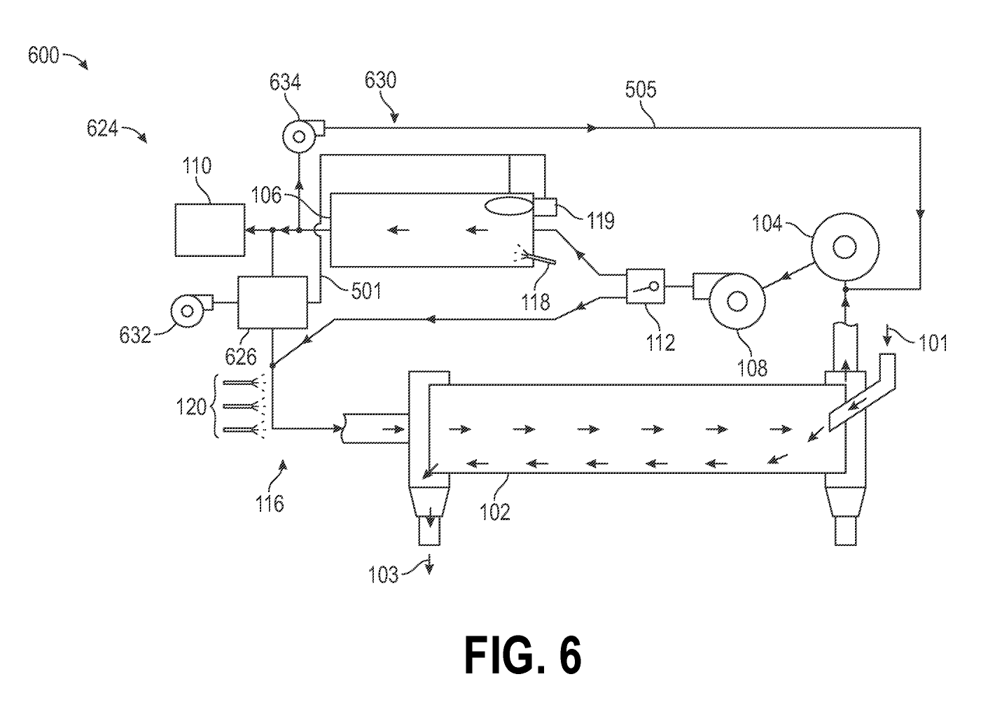

As illustrated in FIG. 1, the cooling system 116 optionally includes one or more of an afterburner sprayer 118, a return sprayer 120, and a kiln sprayer 122. In some examples, the cooling system 116 may omit one or more of the sprayers 118, 120, and 122. The number of afterburner sprayers 118, return sprayers 120, and/or kiln sprayers 122 can vary. In some cases, cooling system 116 only includes a subset of afterburner sprayer 118, return sprayer 120, and kiln sprayer 122 (see, e.g., FIG. 6). The sprayers are configured to inject a coolant into the system. Coolants include, but are not limited to, water, water with oils, halide salts (as a solid coolant or mixed with water or another fluid), or various other materials suitable for reducing the temperature of the gas. In various examples, the sprayers are configured to selectively inject the coolant (i.e. the sprayers do not continuously inject the coolant) into the system. In various examples, the sprayers may be oriented at various angles with respect to the flow path through the system such that the coolant is injected at various angles with respect to the flow path. As some non-limiting examples, the sprayers may be oriented to inject coolant at about 0°, about 1°, about 2°, about 3°, about 4°, about 5°, about 6°, about 7°, about 8°, about 9°, about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, about 35°, about 36°, about 37°, about 38°, about 39°, about 40°, about 41°, about 42°, about 43°, about 44°, about 45°, about 46°, about 47°, about 48°, about 49°, about 50°, about 51°, about 52°, about 53°, about 54°, about 55°, about 56°, about 57°, about 58°, about 59°, about 60°, about 61°, about 62°, about 63°, about 64°, about 65°, about 66°, about 67°, about 68°, about 69°, about 70°, about 71°, about 72°, about 73°, about 74°, about 75°, about 76°, about 77°, about 78°, about 79°, about 80°, about 81°, about 82°, about 83°, about 84°, about 85°, about 86°, about 87°, about 88°, about 89°, and/or about 90° with respect to the flow path. In other examples, angles greater than about 90° may be utilized. Moreover, a subset of the sprayers may be at an angle that is different from the angle of another subset of the sprayers (e.g., the afterburner sprayer 118 could be at a first angle and the kiln sprayer 122 could be at a second angle), although they need not be.

The afterburner sprayer 118 is configured to selectively inject the coolant into the afterburner 106 to mix with the gas in the afterburner 106 and reduce a temperature of the gas within the afterburner 106. In various examples, the afterburner sprayer 118 is positioned proximate to an entrance of the afterburner 106 that receives the gas from the kiln 102, although it need not be. The return sprayer 120 is configured to selectively inject the coolant to mix with the return gas from the afterburner 106 (and optionally the bypass gas diverted by the diverter 112) to reduce a temperature of the return gas before the return gas enters the kiln 102. In some examples, the return sprayer 120 may be provided upstream from where the diverted bypass gas mixes with the return gas, downstream from where the diverted bypass gas mixes with the return gas, or both upstream and downstream from where the diverted bypass gas mixes with the return gas. The kiln sprayer 122 is configured to selectively inject the coolant into a heating chamber of the kiln 102 to mix with gas in the kiln 102 and reduce a temperature of the gas in the kiln 102. In various examples, the kiln sprayer 122 is positioned proximate to an entrance of the kiln 102, although it need not be. Through the afterburner sprayer 118 and/or the return sprayer 120, the decoating system 100 may control the temperature of the return gas while reducing or eliminating the need for the bypass gas from the diverter 112. Through the kiln sprayer 122, the decoating system 100 may control the temperature of the gas in the kiln 102 as needed.

In various examples, the cooling system 116 further includes temperature sensors (not shown) configured to detect temperatures of the gas within the decoating system 100 at various locations (such as in the afterburner 106, in the kiln 102, and between the afterburner 106 and kiln 102). In some examples, the cooling system 116 additionally includes a controller (not shown) in communication with the sprayers 118, 120, and 122 and the temperature sensors to adjust operation of the sprayers 118, 120, and/or 122 based on the sensed temperatures.

In some optional examples, the cooling system 116 further includes kiln discharge chute sprayers that are configured to selectively inject coolant into the kiln discharge chute. For example, in some cases, the kiln discharge chute sprayers are configured to inject the coolant into the kiln discharge chute in order to quench scrap that may pile up during emergency situations including, but not limited to, blockage of the discharge airlock, blockage of the discharge chute, abnormal stop of a discharge vibrating conveyor, or various other emergency or non-emergency situations as desired.

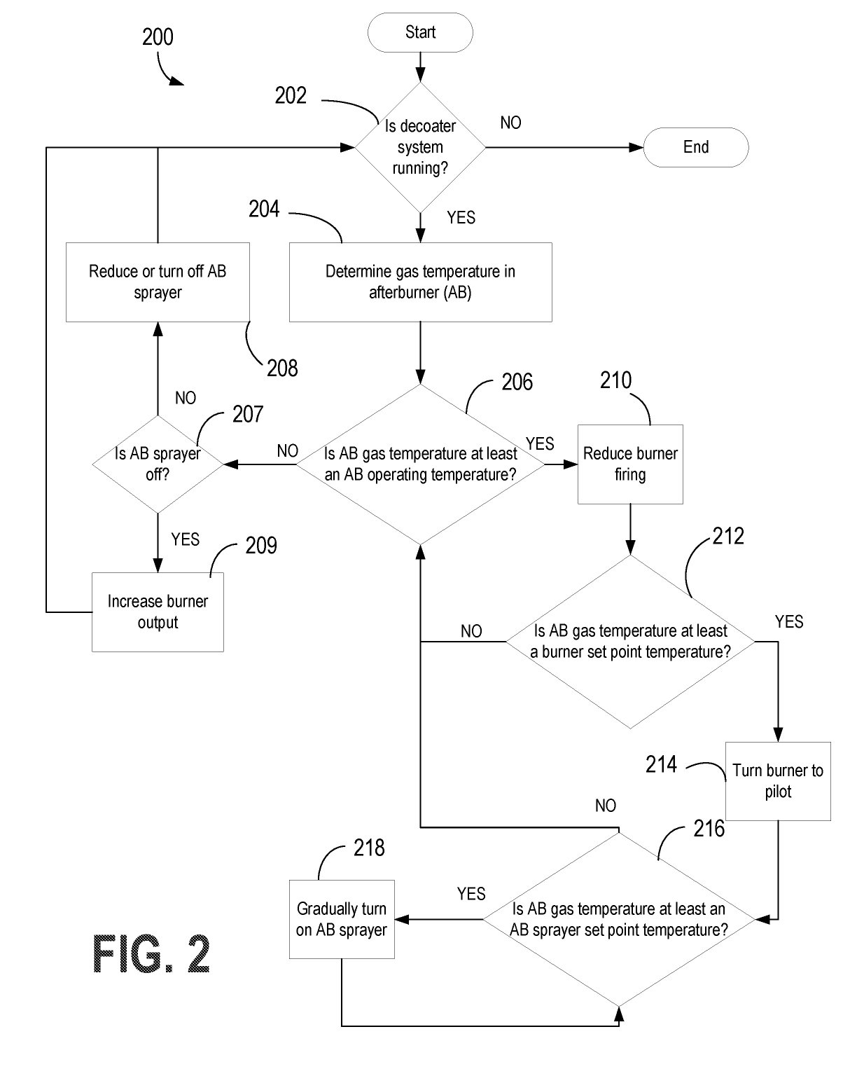

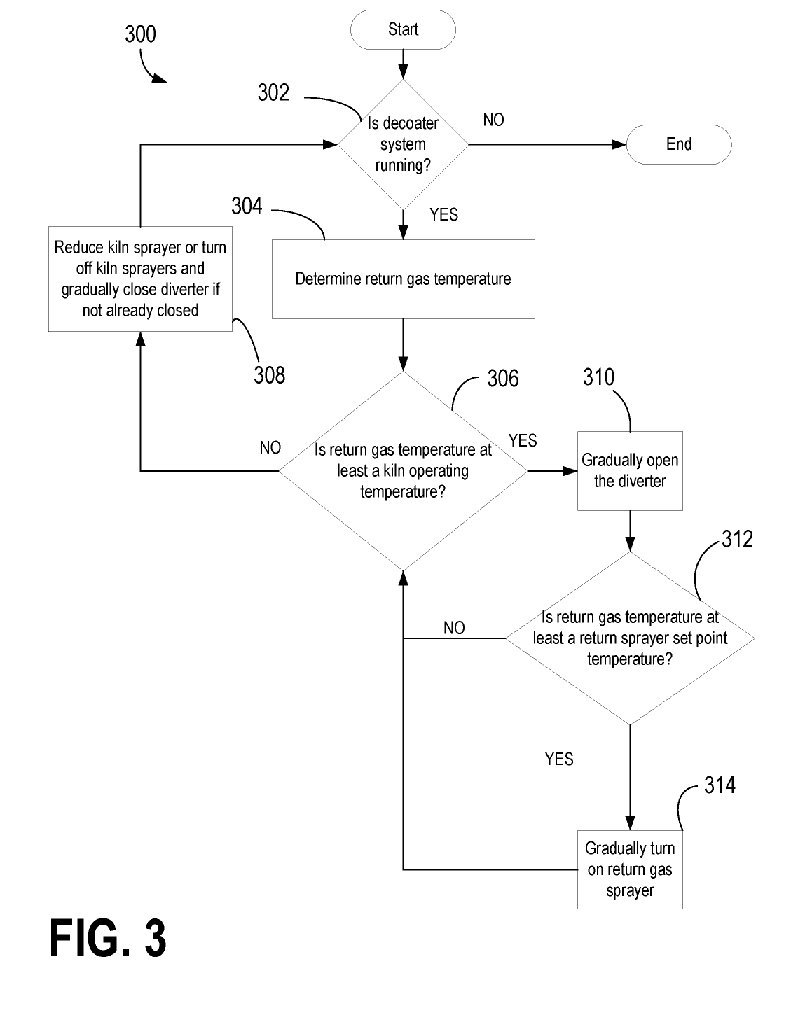

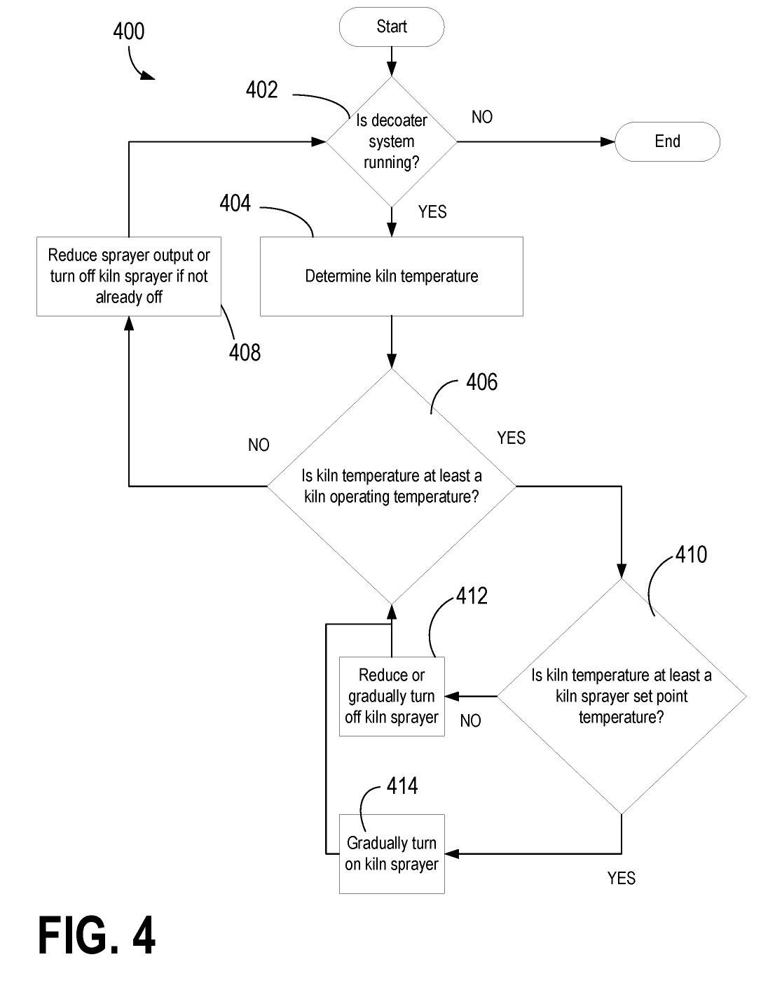

FIGS. 2-4 are flowcharts showing examples of methods of controlling the temperature of the gas at various locations within the decoating system 100 with the cooling system 116. FIG. 2 shows an example of a method 200 of controlling the gas temperature in the afterburner 106 with the cooling system 116. FIG. 3 shows an example of a method 300 of controlling the temperature of the return gas that is used in the kiln 102. FIG. 4 shows an example of a method 400 of controlling the temperature in the kiln 102. In various cases, the methods 200, 300, and 400 may be performed together or selectively as desired.

Referring to FIG. 2, in block 202 of the method 200 for controlling the temperature of the afterburner 106, a controller determines if the decoater system 100 is in operation. In various examples, unless the decoater system 100 is running, the process ends. In block 204, the temperature of the gas in the afterburner 106 is determined. In various examples, the temperature of the gas in the afterburner 106 is sensed through one or more temperature sensors. In some examples, the temperature sensors are within the afterburner 106. Additionally or alternatively, in other examples, temperature sensors measure the temperature of the gas as it exits the afterburner 106.

In block 206, the controller determines whether the temperature detected in block 204 is at least an afterburner operating temperature. In various examples, the afterburner operating temperature is from about 700° C. to about 1000° C., such as about 800° C.+/−20° C. In one non-limiting example, the afterburner operating temperature is about 800° C.

In block 207, if the controller determines in block 206 that the afterburner temperature is not at least the afterburner operating temperature, the controller determines whether the afterburner sprayer 118 is off. In block 209, if the controller determines in block 207 that the afterburner sprayer 118 is not off, the controller reduces the afterburner sprayer 118 and/or turns off the afterburner sprayer 118 if it is not already off and returns to block 202. In block 209, if the controller determines in block 207 that the afterburner sprayer 118 is off, the controller increases the burner output and returns to block 202

In block 210, if the controller determines in block 206 that the afterburner temperature is at least the afterburner operating temperatures, the controller 210 gradually reduces burner firing of a burner of the afterburner 106. In block 212, the controller then determines if the afterburner temperature is at least a burner set point temperature. In various examples, the burner set point temperature is a temperature greater than the afterburner operating temperature and less than an afterburner sprayer set point temperature. In some non-limiting examples, the burner set point temperature is about 800° C. to about 810° C., although various other temperature ranges may be provided. If the controller determines that the afterburner gas temperature is not at least the burner set point temperature, the process returns to block 206. If the controller determines in block 212 that the afterburner temperature is at least the burner set point temperature, the controller reduces the burner to a pilot setting such that a stable minimum is retained to safely ignite the organic vapors and prevent explosions in block 214. Optionally, the controller turns off the burner in block 214.

In block 216, the controller determines whether the afterburner temperature is at least an afterburner sprayer set point temperature. In various examples, the afterburner sprayer set point temperature is greater than the afterburner operating temperature. In one non-limiting example, the afterburner set point temperature is about 820° C., although various other temperatures may be used. If the controller determines that the afterburner temperature is not at least the afterburner sprayer set point temperature, the process returns to block 206. If the controller determines that the afterburner temperature is at least the afterburner sprayer set point temperature, in block 218, the controller gradually turns on the afterburner sprayer 118 and returns to block 216.

Referring to FIG. 3, in block 302 of the method 300 for controlling the temperature of the return gas entering the kiln 102, the controller determines if the decoater system 100 is in operation. Similar to the method 200, unless the decoater system 100 is running, the process ends. In block 304, the temperature of the return gas is sensed through temperature sensors. In block 306, the controller determines whether the return gas temperature detected in block 304 is at least a kiln operating temperature. In various examples, the kiln operating temperature is from about 200° C. to about 600° C., such as about 550° C.+/−20° C. For example, in one non-limiting case, the kiln operating temperature is about 550° C. In block 308, if the controller determines in block 306 that the return gas temperature is not above the kiln operating temperature, the controller reduces the sprayer output and/or turns off all of the sprayers if they are not already off, closes the diverter 112 if it is not already closed, and then returns to block 302.

In block 310, if the controller determines in block 306 that the return gas temperature is at least the kiln operating temperature, the controller gradually opens the diverter 310 such that more bypass gas is diverted from the main gas flow exiting the kiln 102 rather than being fed into the afterburner 106. In block 312, the controller determines whether the return gas temperature is at least a return sprayer set point temperature. In various examples, the return sprayer set point temperature is greater than the kiln operating temperature. For example, in one non-limiting case, the return sprayer set point temperature is about 570° C., although various other temperatures may be used. If the controller determines that the return gas temperature is not at least the return sprayer set point temperature, the process returns to block 306. If the controller determines that the return gas temperature is at least the return gas set point temperature, in block 314, the controller gradually turns on the return sprayer 120, and then proceeds to block 306.

Referring to FIG. 4, in block 402 of the method 400 for controlling the temperature of the kiln 102, the controller determines if the decoater system 100 is in operation. In various examples, similar to the methods 200 and 300, unless the decoater system 100 is running, the process ends. In block 404, the temperature of the kiln 102 is sensed through temperature sensors.

In block 406, the controller determines whether the kiln temperature detected in block 404 is at least the kiln operating temperature. In block 408, if the controller determines in block 406 that the kiln temperature is not at least the kiln operating temperature, the controller reduces the sprayer output and/or turns off the kiln sprayer 122 if it is not already off, and returns to block 402. In block 410, if the controller determines that the kiln temperature is at least the kiln operating temperature, the controller determines whether the kiln temperature is at least a kiln sprayer set point temperature. In various examples, the kiln sprayer set point temperature is greater than the kiln operating temperature. For example, in one non-limiting case, the kiln sprayer set point temperature is about 570° C., although various other temperatures may be used.

In block 412, if the kiln temperature is not at least the kiln sprayer set point temperature, the controller reduces and/or gradually turns off the kiln sprayer 122 if it is on, and returns to block 406. In block 414, if the kiln temperature is at least the kiln sprayer set point temperature, the controller gradually turns on the kiln sprayer 122 or further opens the kiln sprayer 122 if it is already on, and returns to block 406.

In other examples, controlling the return gas temperature includes continuously using the sprayers 118, 120, and/or 122, and selectively using the diverter 112 as needed, to further control the return gas temperature. In various other examples, controlling the return gas temperature includes continuously using the diverter 112 to direct the bypass gas to mix with the return gas, and selectively using the sprayers 118, 120, and/or 122 as needed to further control the return gas temperature. Numerous other configurations of using the diverter 112 and sprayers 118, 120, 122 may be implemented.

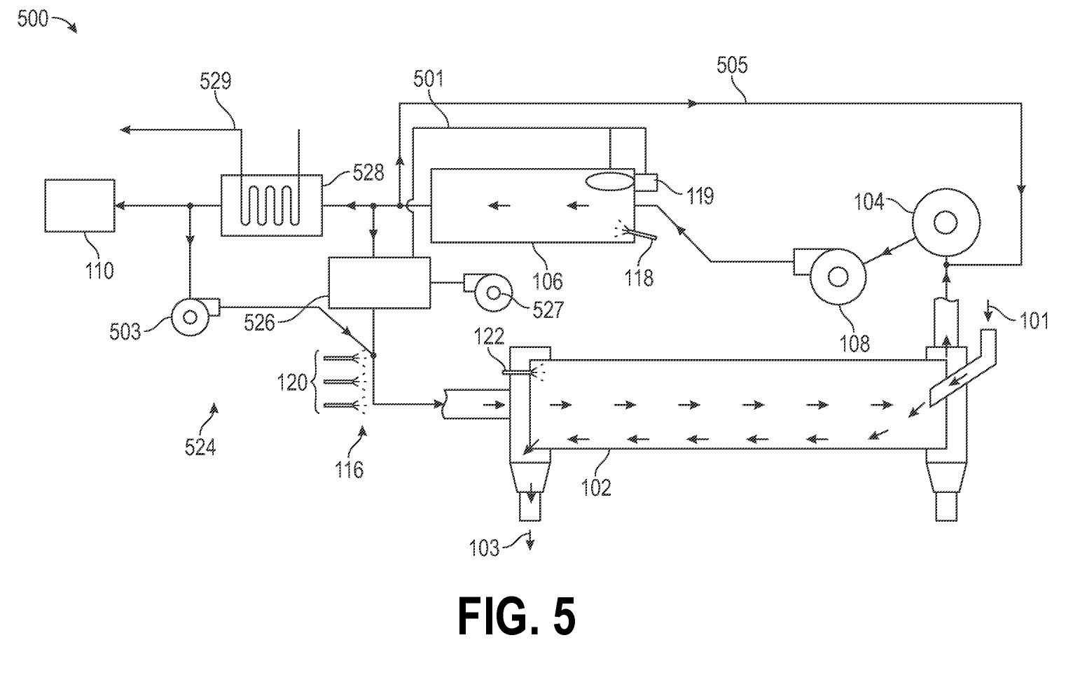

FIG. 5 illustrates a decoating system 500 according to aspects of the present disclosure. Similar to the decoating system 100, the decoating system 500 includes the cooling system 116, although in some instances cooling system 116 is not used. In addition to the cooling system 116, the decoating system 500 further includes a heat exchange system 524. In various examples, the heat exchange system 524 includes a heat exchanger 526, which can be an air-to-air heat exchanger (or gas/gas heat exchanger, oil/gas heat exchanger, water/gas heat exchanger, coolant/gas heat exchanger, or other suitable heat exchanger), and a steam generator 528, which is a coolant heat exchanger using water or another suitable fluid. In the example of FIG. 5, the heat exchanger includes a cooling fan 527.

As illustrated in FIG. 5, some of the return gas exiting the afterburner 106 is diverted to the heat exchanger 526 where the return gas is cooled from the afterburner operating temperature to an intermediate temperature. In some examples, the intermediate temperature is a temperature less than the afterburner operating temperature and greater than the kiln operating temperature. For example, the intermediate temperature may be from about 400° C. to about 750° C., such as from about 600° C. to about 550° C. In other examples, the heat exchanger 526 is configured to cool the return gas from the afterburner operating temperature to the kiln operating temperature. In various examples, the intermediate temperature is about the kiln operating temperature. Some of the heat removed from the return gas by the heat exchanger 526 may optionally be recirculated back to the afterburner 106 as preheated air 501 for oxygen control within the afterburner 106 and/or combustion air for burner firing of the afterburner 106. The cooled return gas is then directed from the heat exchanger 526 to the kiln 102.

Optionally, some of the return gas exiting the afterburner 106 can also be selectively recirculated back to the cyclone 104 as recirculated gas 505 to control a temperature of the cyclone 104. The gas exiting the afterburner 106 that is not the return gas diverted to the heat exchanger 526 and not the recirculated gas recirculated to the cyclone 104 is directed to the steam generator 528 as exhaust gas. Within the steam generator 528, the temperature of the exhaust gas exiting the afterburner 106 is reduced from the afterburner operating temperature to a cooled temperature of about 100° C. to about 800° C., such as about 200° C. to about 750° C., by heating a coolant or converting the coolant into steam 529. In various examples, the coolant is supplied from a coolant source such as various storage facilities, suppliers, utility providers, etc. If steam is produced, steam generated by the steam generator 528 may be vented into the atmosphere or may be used in other processes rather than being lost as waste. For example, the steam can be sold to third parties that can use the steam as a fuel source. If hot coolant is produced, it can be directed to for use in other processes or for building heat.

From the steam generator 528, the exhaust gas is directed to the exhaust system 110 for further processing. As illustrated in FIG. 5, some of the cooled exhaust gas from the steam generator 528 may be selectively recirculated to mix with the cooled return gas exiting the heat exchanger 526 to further control the temperature of the return gas before it enters the kiln 102. For example, in some cases, the temperature of the cooled return gas from the heat exchanger 526 may be greater than the kiln operating temperature. In such cases, a cooling fan 503 diverts some of the cooled exhaust gas from the steam generator 524 to mix with the cooled return gas exiting the heat exchanger 526 to further reduce the gas temperature of the return gas before it enters the kiln 102.

FIG. 6 illustrates a decoating system 600 according to aspects of the present disclosure. Similar to the decoating system 100, the decoating system 600 includes the cooling system 116, although in some instances cooling system 116 is not used. As illustrated in FIG. 6, the cooling system 116 in the decoating system 600 includes the afterburner sprayer 118 and the return sprayer 120, but could use fewer or additional sprayers.

In addition to the cooling system 116, the decoating system 600 further includes a heat exchange system 624. Similar to the heat exchange system 524, the heat exchange system includes a heat exchanger 626, which may be an air-to-air heat exchanger or other suitable heat exchanger. A cooling fan 632 directs cooling air through the heat exchanger 626 to remove heat from the return gas exiting the afterburner 106. As illustrated in FIG. 6, at least some of the cooled air exits the heat exchanger 626 as preheated air 501 for oxygen control within the afterburner 106 and/or combustion air for the burner of the afterburner 106.

The decoating system 600 also includes a cyclone control system 630. The cyclone control system 630 includes a fan 634 that selectively diverts at least some of the exhaust gas from the afterburner 106 as recirculation gas 505 provided to the cyclone 104. A valve or other metering device (not shown) may be provided to enable or restrict the fan 634 to recirculate the recirculation gas 505. The cyclone control system 630 is configured to control a temperature of the cyclone (cyclone temperature) and/or to control an atmosphere created by the gas within the cyclone 104.

Because a temperature of the recirculation gas 505 is generally greater than a temperature of the gas exiting the kiln 102, the cyclone control system 630 can selectively mix the recirculation gas 505 with the gas exiting the kiln 102 to control the cyclone temperature. In some examples, the cyclone control system 630 is configured to control the cyclone temperature such that the cyclone temperature is at or above a threshold cyclone temperature.

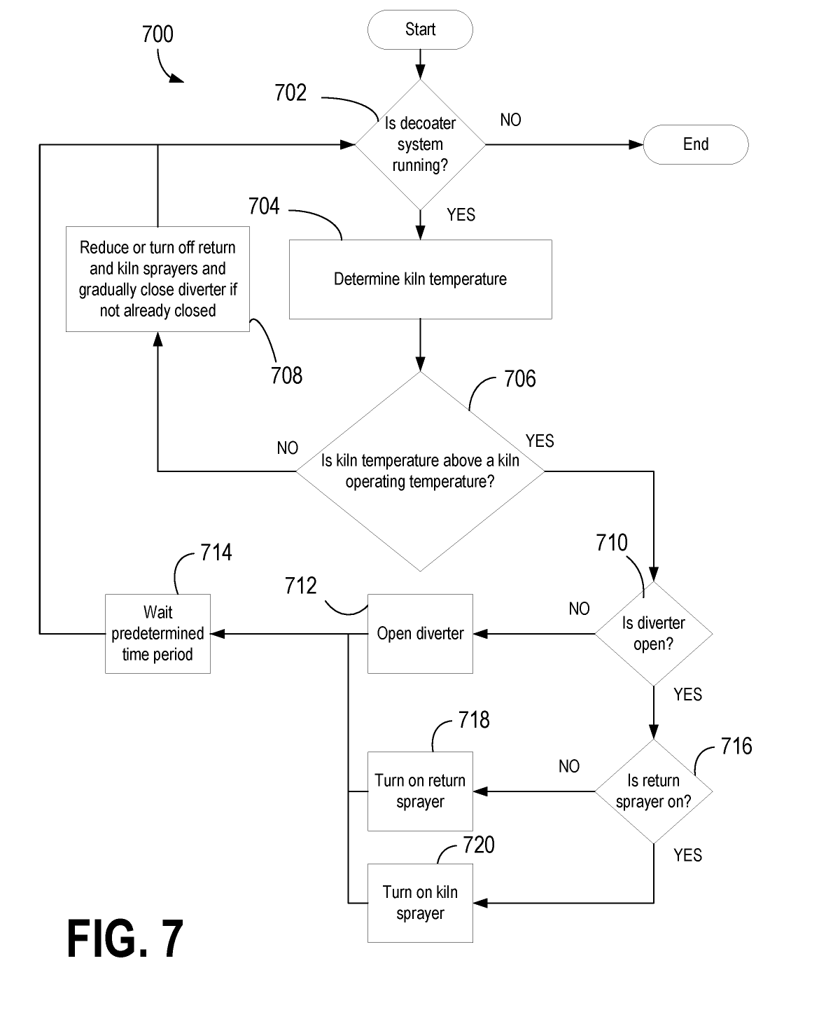

FIG. 7 illustrates another example of a method 700 for controlling the temperature of the return gas entering the kiln 102 (and thus the kiln temperature). In block 702, the controller determines if the decoater system 100 is in operation. Unless the decoater system 100 is running, the process ends. In block 704, the temperature within the kiln 102 is sensed through temperature sensors. In block 706, the controller determines whether the kiln temperature detected in block 704 is above a kiln operating temperature. In various examples, the kiln operating temperature is from about 200° C. to about 600° C. In block 708, if the controller determines in block 706 that the kiln temperature is not above the kiln operating temperature, the controller turns off the sprayers 120 and 122 if they are not already off, closes the diverter 112 if it is not already closed, and then returns to block 702.

In block 710, if the controller determines in block 706 that the kiln temperature is above the kiln operating temperature, the controller determines whether the diverter 112 is open. If the diverter 112 is not open, in block 712, the controller at least partially opens the diverter 112 such that at least some of the bypass gas is diverted from the main gas flow exiting the kiln 102 rather than being fed into the afterburner 106. In some examples, the position to which the diverter 112 is opened may depend on the kiln temperature. From the block 712, the process proceeds to block 714 where it waits for a predetermined time period before returning to block 702. If the diverter 112 is open in block 710, the controller proceeds to block 716 where it determines whether the return sprayer 120 is on. In block 718, if the controller determines that the return sprayer 120 is not on, the controller turns on the return sprayer 120 and proceeds to block 714. In block 720, if the controller determines that the return sprayer 120 is not on, the controller turns on the kiln sprayer 122, and then proceeds to block 714.

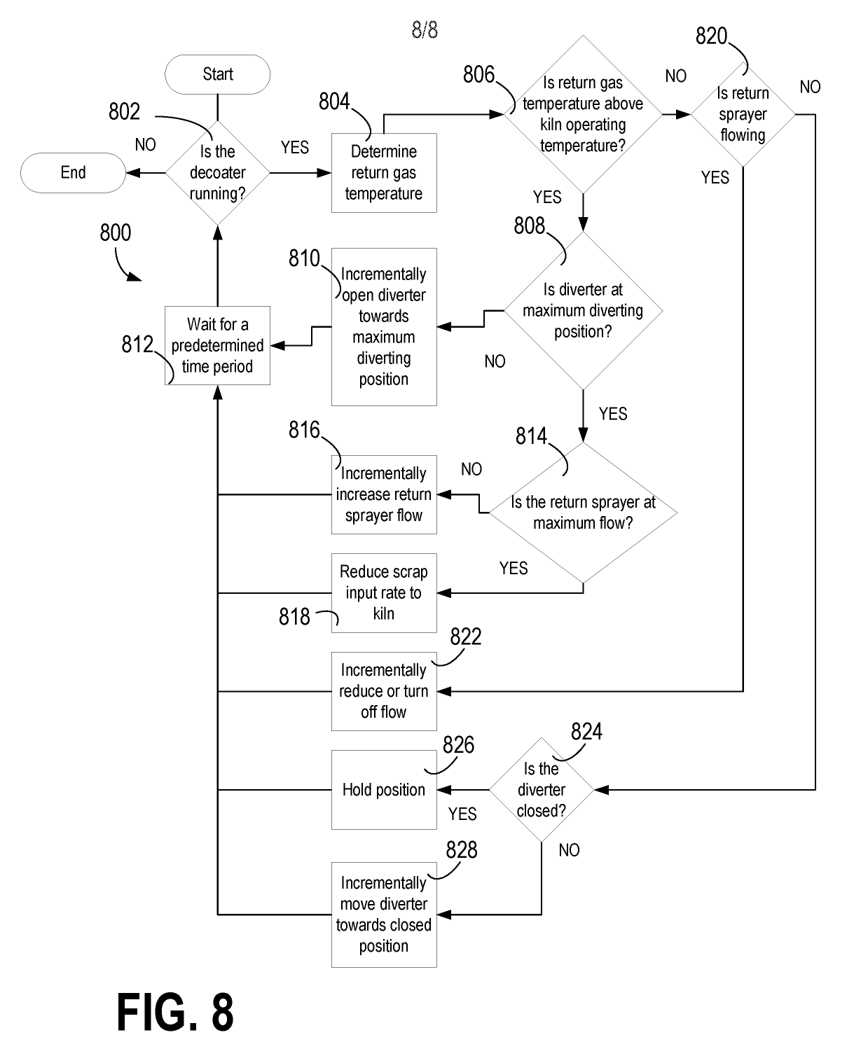

FIG. 8 illustrates another example of a method 800 for controlling the temperature of the return gas entering the kiln 102 (and thus the kiln temperature). In block 802, the controller determines if the decoater system 100 is in operation. Unless the decoater system 100 is running, the process ends. In block 804, the temperature of the return gas is sensed with temperature sensors. In block 806, the controller determines whether the return gas temperature detected in block 804 is above the kiln operating temperature.

In block 808, if the controller determines in block 806 that the return gas temperature is above the kiln operating temperature, the controller determines whether the diverter 112 is at a maximum diverting position. In the maximum diverting position, a maximum amount of gas is diverted as bypass gas rather than moving to the afterburner 106. In block 810, if the diverter 112 is not at the maximum diverting position, the diverter is incrementally opened towards the maximum diverting position. The amount of incremental opening of the diverter 112 may be predetermined, although in other examples it need not be. The amount of incremental opening may further be at fixed increments or variable increments. In block 812, the process waits for a predetermined time period before returning to block 802.

In block 814, if the controller determines in block 808 that the diverter is at the maximum diverting position, the controller determines whether the return sprayer 120 is at a maximum flow (i.e., discharging a maximum amount of coolant). In block 816, if the controller determines in block 814 that the return spray 120 is not at a maximum flow, the flow of the return sprayer 120 is incrementally increased. The amount of incremental flow increase may be predetermined, although in other examples it need not be. The amount of incremental flow increase may further be at fixed increments or variable increments. From block 816, the process proceeds to block 812. In block 818, if in block 814 the controller determines that the return spray 120 is at the maximum flow, the rate of scrap input into the kiln 102 is reduced, and the process then proceeds to block 812.

In block 820, if in block 806 the controller determines that the return gas temperature is not above the kiln operating temperature, the controller determines whether the return spray 120 is flowing. If the return spray 120 is flowing in block 820, in block 822, the flow of the return sprayer 120 is incrementally reduced and/or turned off, and the process proceeds to block 812. If the return sprayer 120 is not flowing in block 820, in block 824, the controller determines whether the diverter 112 is in the closed position. If the diverter 112 is in the closed position, in block 826 the controller holds the position of the diverter 112 and proceeds to block 812. If the controller determines in block 824 that the diverter is not in the closed position, the diverter is incrementally moved toward the closed position such that more gas exiting the cyclone 104 is directed towards the afterburner 118 in block 828.

A collection of exemplary examples, including at least some explicitly enumerated as “ECs” (Example Combinations), providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

EC 1. A decoating system comprising: an afterburner; a kiln; and a cooling system comprising a return sprayer configured to selectively cool a return gas flowing from the afterburner to the kiln with a coolant.

EC 2. The decoating system of any of the preceding or subsequent example combinations, wherein the cooling system further comprises a kiln sprayer configured to inject the coolant into the kiln to control a gas temperature within the kiln.

EC 3. The decoating system of the preceding or subsequent example combinations, wherein the cooling system further comprises an afterburner sprayer configured to inject the coolant into the afterburner to control a gas temperature within the afterburner.

EC 4. The decoating system of the preceding or subsequent example combinations, wherein the coolant is water, and wherein the cooling system is configured to cool the return gas from an afterburner operating temperature to a kiln operating temperature.

EC 5. The decoating system of the preceding or subsequent example combinations, further comprising a diverter, wherein the diverter is configured to selectively divert a bypass gas exiting the kiln to mix with the return gas flowing from the afterburner to the kiln.

EC 6. The decoating system of the preceding or subsequent example combinations, further comprising a heat exchange system, wherein the heat exchange system comprises a heat exchanger and a steam generator or heat exchanger.

EC 7. The decoating system of the preceding or subsequent example combinations, wherein the heat exchanger is configured to cool the return gas flowing from the afterburner to the kiln from an afterburner operating temperature to an intermediate temperature.

EC 8. The decoating system of the preceding or subsequent example combinations, wherein the steam generator or high temperature heat exchanger is configured to cool an exhaust gas discharged from the afterburner from the afterburner operating temperature to a cooled temperature, and wherein the heat exchange system is configured to selectively mix some of the exhaust gas from the steam generator at the cooled temperature with the return gas from the heat exchanger at the intermediate temperature to reduce the return gas from the heat exchanger from the intermediate temperature to a kiln operating temperature.

EC 9. The decoating system of the preceding or subsequent example combinations, wherein the heat exchanger is configured to warm air when cooling the return gas to the intermediate temperature, and wherein the heat exchange system is further configured to direct the warm air from the heat exchanger to the afterburner.

EC 10. The decoating system of the preceding or subsequent example combinations, wherein an oxygen level in the afterburner is controlled using the warm air.

EC 11. The decoating system of the preceding or subsequent example combinations, wherein the warm air is combustion air for burner firing of the afterburner.

EC 12. The decoating system of the preceding or subsequent example combinations, wherein the kiln is a counterflow kiln.

EC 13. A decoating system comprising: a kiln; and a cooling system comprising a kiln sprayer configured to selectively inject a coolant into the kiln to control a temperature of a gas within the kiln.

EC 14. The decoating system of the preceding or subsequent example combinations, further comprising an afterburner, wherein the gas flows from the afterburner to the kiln, and wherein the cooling system further comprises a bypass sprayer configured to cool the gas from an afterburner operating temperature to a kiln operating temperature.

EC 15. The decoating system of the preceding or subsequent example combinations, wherein the cooling system further comprises an afterburner sprayer configured to inject the coolant into the afterburner to control a gas temperature within the afterburner.

EC 16. The decoating system of the preceding or subsequent example combinations, further comprising: an afterburner, wherein the gas flows from the afterburner to the kiln; and a heat exchange system comprising a heat exchanger and a steam generator.

EC 17. The decoating system of the preceding or subsequent example combinations, wherein: the heat exchanger is configured to cool the gas flowing from the afterburner to the kiln from an afterburner operating temperature to an intermediate temperature; the steam generator is configured to cool an undiverted gas discharged from afterburner from the afterburner operating temperature to a cooled temperature; and the heat exchange system is configured to selectively mix some of the undiverted gas from the steam generator at the cooled temperature with the gas from the heat exchanger at the intermediate temperature to reduce the gas from the heat exchanger from the intermediate temperature to a kiln operating temperature.

EC 18. The decoating system of the preceding or subsequent example combinations, further comprising a diverter, wherein the diverter is configured to selectively divert a bypass gas exiting the kiln to mix with the gas flowing from the afterburner to the kiln.

EC 19. A method of controlling a temperature in a decoating system comprising: measuring a return gas temperature of a return gas flowing from an afterburner of the decoating system to a kiln of the decoating system; comparing the return gas temperature to a kiln operating temperature of the kiln; and activating a return sprayer of a cooling system and injecting a coolant into the return gas to cool the return gas if the return gas temperature is greater than the kiln operating temperature.

EC 20. The method of the preceding or subsequent example combinations, further comprising after the measuring and before the comparing: comparing the return gas temperature to the kiln operating temperature of the kiln after measuring the return gas temperature; and activating an afterburner sprayer of the cooling system and injecting the coolant into the afterburner.

EC 21. The method of the preceding or subsequent example combinations, further comprising: determining a position of a diverter; opening the diverter to an open position and directing bypass gas exiting the kiln to mix with the return gas flowing from the afterburner to the kiln if the diverter is in a closed position; and activating a kiln sprayer of the cooling system and injecting the coolant into the kiln if the diverter is in the open position.

EC 22. The method of the preceding or subsequent example combinations, further comprising: directing the return gas flowing from the afterburner to the kiln to flow through a heat exchanger of a heat exchange system and reducing the temperature from an afterburner operating temperature to an intermediate temperature.

EC 23. The method of the preceding or subsequent example combinations, further comprising: directing exhaust gas exiting the afterburner through a steam generator and reducing a temperature of the exhaust gas from the afterburner operating temperature to a cooled temperature; and mixing at least some of the exhaust gas from the steam generator at the cooled temperature with the return gas from the heat exchanger at the intermediate temperature.

EC 24. A decoating system comprising: a kiln configured to discharge a kiln gas; a cyclone configured to receive the kiln gas, filter organic particulate matter from the kiln gas, and discharge the filtered kiln gas; an afterburner configured to heat the filtered kiln gas and discharge an exhaust gas, wherein at least some of the exhaust gas is diverted as return gas flowing from the afterburner to the kiln; a heat exchange system comprising a heat exchanger configured to cool the return gas; and a cyclone control system configured to control a cyclone temperature of the cyclone.

EC 25. The decoating system of the preceding or subsequent example combinations, wherein the cyclone control system controls the cyclone temperature by selectively diverting at least some of the exhaust gas as recirculation gas and mixing the recirculation gas with the kiln gas.

EC 26. The decoating system of the preceding or subsequent example combinations, further comprising a cooling system comprising a return sprayer configured to selectively cool the return gas flowing from the afterburner to the kiln with a coolant.

EC 27. The decoating system of the preceding or subsequent example combinations, wherein the cooling system further comprises an afterburner sprayer configured to inject the coolant into the afterburner to control a gas temperature within the afterburner.

EC 28. The decoating system of the preceding or subsequent example combinations, wherein the heat exchanger is configured to warm air when cooling the return gas, and wherein the heat exchange system is further configured to direct the warm air from the heat exchanger to the afterburner.

EC 29. The decoating system of the preceding or subsequent example combinations, wherein an oxygen level in the afterburner is controlled using the warm air.

EC 30. The decoating system of the preceding or subsequent example combinations, wherein the warm air is combustion air for burner firing of the afterburner.

EC 31. The decoating system of the preceding or subsequent example combinations, wherein the cyclone control system comprises a fan.

EC 32. A decoating system comprising: a kiln; an afterburner configured to discharge an exhaust gas; and a heat exchange system comprising a steam generator and a heat exchanger, wherein at least some of the exhaust gas is directed from the afterburner to the kiln as return gas, wherein the heat exchanger is configured to cool the return gas, and wherein the steam generator is configured to cool the exhaust gas that is not cooled by the heat exchanger.

EC 33. The decoating system of the preceding or subsequent example combinations, wherein the heat exchanger is configured to cool the return gas from an afterburner operating temperature to an intermediate temperature.

EC 34. The decoating system of the preceding or subsequent example combinations, wherein the afterburner operating temperature is from about 700° C. to about 1000° C., and wherein the intermediate temperature is from about 400° C. to about 750° C.

EC 35. The decoating system of the preceding or subsequent example combinations, wherein the intermediate temperature is greater than a kiln operating temperature.

EC 36. The decoating system of the preceding or subsequent example combinations, wherein the kiln operating temperature is from about 200° C. to about 600° C.

EC 37. The decoating system of the preceding or subsequent example combinations, wherein the intermediate temperature is a kiln operating temperature.

EC 38. The decoating system of the preceding or subsequent example combinations, wherein the steam generator is configured to cool the exhaust gas from an afterburner operating temperature to a cooled exhaust temperature.

EC 39. The decoating system of the preceding or subsequent example combinations, wherein the cooled exhaust temperature is from about 100° C. to about 700° C.

EC 40. The decoating system of the preceding or subsequent example combinations, wherein the heat exchange system further comprises a cooling fan configured to direct at least some of the exhaust gas from the steam generator at the cooled exhaust temperature to mix with the cooled return gas from the heat exchanger.

EC 41. The decoating system of the preceding or subsequent example combinations, further comprising a cooling system, wherein the cooling system comprises: a return sprayer configured to selectively cool the return gas; a kiln sprayer configured to inject a coolant into the kiln to control a gas temperature within the kiln; and an afterburner sprayer configured to inject the coolant into the afterburner to control a gas temperature within the afterburner.

The above-described aspects are merely possible examples of implementations, merely set forth for a clear understanding of the principles of the present disclosure. Many variations and modifications can be made to the above-described example(s) without departing substantially from the spirit and principles of the present disclosure. All such modifications and variations are included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed is:

1. A decoating system comprising:
an afterburner;
a kiln; and
a cooling system comprising a return sprayer configured to selectively cool a return gas flowing from the afterburner to the kiln with a coolant.

2. The decoating system of claim 1, wherein the cooling system further comprises a kiln sprayer configured to inject the coolant into the kiln to control a gas temperature within the kiln.

3. The decoating system of claim 1, wherein the cooling system further comprises an afterburner sprayer configured to inject the coolant into the afterburner to control a gas temperature within the afterburner.

4. The decoating system of claim 1, wherein the coolant is water, and wherein the cooling system is configured to cool the return gas from an afterburner operating temperature to a kiln operating temperature.

5. The decoating system of claim 1, further comprising a diverter, wherein the diverter is configured to selectively divert a bypass gas exiting the kiln to mix with the return gas flowing from the afterburner to the kiln.

6. The decoating system of claim 1, further comprising a heat exchange system, wherein the heat exchange system is configured to cool the return gas flowing from the afterburner to the kiln from an afterburner operating temperature to an intermediate temperature.

7. The decoating system of claim 6, wherein the heat exchange system is configured to cool an exhaust gas discharged from the afterburner from the afterburner operating temperature to a cooled temperature, and wherein the heat exchange system is configured to selectively reduce the return gas from the heat exchanger from the intermediate temperature to a kiln operating temperature.

8. The decoating system of claim 6, wherein the heat exchanger is configured to warm air when cooling the return gas to the intermediate temperature, and wherein the heat exchange system is further configured to direct the warmed air from the heat exchanger to the afterburner.

9. The decoating system of claim 8, wherein the warmed air is combustion air for burner firing of the afterburner.

10. A method of controlling a temperature in a decoating system comprising:
measuring a return gas temperature of a return gas flowing from an afterburner of the decoating system to a kiln of the decoating system;
comparing the return gas temperature to a kiln operating temperature of the kiln; and
activating a return sprayer of a cooling system and injecting a coolant into the return gas to cool the return gas if the return gas temperature is greater than the kiln operating temperature.

11. The method of claim 10, further comprising after the measuring and before the comparing:
comparing the return gas temperature to the kiln operating temperature of the kiln after measuring the return gas temperature; and
activating an afterburner sprayer of the cooling system and injecting the coolant into the afterburner.

12. The method of claim 10, further comprising:
determining a position of a diverter;
opening the diverter to an open position and directing bypass gas exiting the kiln to mix with the return gas flowing from the afterburner to the kiln if the diverter is in a closed position; and
activating a kiln sprayer of the cooling system and injecting the coolant into the kiln if the diverter is in the open position.

13. The method of claim 10, further comprising:
directing the return gas flowing from the afterburner to the kiln to flow through a heat exchanger of a heat exchange system and reducing the temperature from an afterburner operating temperature to an intermediate temperature.

14. The method of claim 13, further comprising:
directing exhaust gas exiting the afterburner through a steam generator and reducing a temperature of the exhaust gas from the afterburner operating temperature to a cooled temperature; and
mixing at least some of the exhaust gas from the steam generator at the cooled temperature with the return gas from the heat exchanger at the intermediate temperature.

15. A decoating system comprising:
a kiln configured to discharge a kiln gas;
a cyclone configured to receive the kiln gas, filter organic particulate matter from the kiln gas, and discharge the filtered kiln gas;
an afterburner configured to heat the filtered kiln gas and discharge an exhaust gas, wherein at least some of the exhaust gas is diverted as return gas flowing from the afterburner to the kiln;
a heat exchange system configured to cool the return gas; and
a cyclone control system configured to control a cyclone temperature of the cyclone.

16. The decoating system of claim 15, wherein the cyclone control system controls the cyclone temperature by selectively diverting at least some of the exhaust gas as recirculation gas and mixing the recirculation gas with the kiln gas.

17. The decoating system of claim 15, further comprising a cooling system comprising a return sprayer configured to selectively cool the return gas flowing from the afterburner to the kiln with a coolant.

18. The decoating system of claim 17, wherein the cooling system further comprises an afterburner sprayer configured to inject the coolant into the afterburner to control a gas temperature within the afterburner.

19. The decoating system of claim 15, wherein the heat exchange system is configured to warm air when cooling the return gas, and wherein the heat exchange system is further configured to direct the warmed air from the heat exchanger to the afterburner.

20. The decoating system of claim 19, wherein the warmed air is combustion air for burner firing of the afterburner.
